(19) United States
(12) Patent Application Publication
(10) Pub. No.: US 2026/0216833 A1
(43) Pub. Date: Jul. 30, 2026

(54) DEVICE FOR STORING AND DISTRIBUTING ASSEMBLY COMPONENTS PROVIDED WITH AT LEAST ONE ROTARY MEANS FOR TRANSFERRING ASSEMBLY COMPONENTS

(71) Applicant: SETI-TEC, COLLEGIEN (FR)

(72) Inventor: Sébastien PEREIRA SANTO, CHARNECA DA CAPARICA (PT)

(21) Appl. No.: 19/139,005

(22) PCT Filed: Dec. 13, 2023
(86) PCT No.: PCT/EP2023/085539

§ 371 Date: Jun. 13, 2025

(30) Foreign Application Priority Data
Dec. 22, 2022 (FR) FR2214311

(51) Int. Cl. B23P 19/00; B65G 1/04; B65G 29/00; B65G 47/14; B65G 47/91

(52) U.S. Cl. CPC B23P 19/004; B65G 29/00; B65G 47/1485; B65G 47/915; B65G 1/045

(57) ABSTRACT

A device for storing and dispensing assembly components. The device includes: containers; an extractor, associated with each of the containers, for extracting components from said container; a conveying element for conveying extracted components to at least one remote workstation; and a transfer element for transferring extracted assembly components to the conveyor. The containers are arranged radially around a central axis, and the transfer element includes a gripper for gripping at least one assembly component extracted by the extractor, the gripper being respectively carried by a movable arm rotating about the central axis so as to transfer to the conveying element each assembly component extracted from one of said containers from which it is extracted.

### 1. CROSS-REFERENCE TO RELATED APPLICATIONS

This Application is a Section 371 National Stage Application of International Application No. PCT/EP2023/085539, filed Dec. 13, 2023, and published as WO 2024/132757 A1 on Jun. 27, 2024, not in English, which claims priority to and the benefit of French Patent Application No. 2214311, filed Dec. 22, 2022, the contents of which are incorporated herein by reference in their entireties.

### 2. TECHNICAL FIELD

The field of the invention is that of designing and making devices for storing and dispensing assembly components used in industry, in particular aeronautics, for transferring fastening elements between a supply area and a dispensing area.

### 3. PRIOR ART

Assembly components (such as screws, rivets, or others) are commonly used in industry to make assemblies.

For this purpose, it is necessary to move these assembly components from a supply area where they are stored to a dispensing area where they are brought with a view to being subsequently positioned by means of an assembly tool.

Among the known solutions, there are devices for storing and dispensing assembly components which respectively comprise:
a plurality of component containers,
means for extracting, from the containers, associated components,
means of conveying, to at least one remote workstation, components extracted from the containers by the extraction means, and
means of transferring, to the conveying means, components extracted from the containers by the extraction means.

However, the known means for ensuring such a transfer are quite inefficient, inaccurate, complex and/or cumbersome and can therefore be improved.

It is therefore still possible to improve devices of this type, which constitutes an objective pursued by the invention.

### 4. DISCLOSURE OF THE INVENTION

The proposed technique relates to a device for storing and dispensing assembly components comprising:
a plurality of containers capable of containing assembly components,
means for extracting assembly components out of the containers, the means for extracting being respectively associated with each of the containers,
means for conveying, to at least one remote workstation, assembly components extracted from the containers by the means for extracting,
means for transferring, to the means for conveying, assembly components extracted from the containers by the means for extracting.

According to the invention, the containers are arranged radially around a central axis.

Furthermore, the means for transferring comprise means for gripping at least one assembly component extracted by the means for extracting, the means for gripping being respectively carried by an arm movable in rotation about the central axis so as to transfer to the distribution means each assembly component extracted from one of the containers from which it is extracted.

Such an arrangement makes it possible in particular to limit the footprint of the device, even more so when implementing the invention in a staged device. Such a device also makes it possible to improve the transfer rate of the assembly components.

According to a particular feature of the device, at least one of the means for gripping is a means for unitary gripping of an assembly component extracted by the associated means for extracting.

The implementation of such a means for unitary gripping therefore allows selective gripping of a single assembly component. This means, among other things, effective gripping and transfer of the assembly component. This is because gripping of a plurality of assembly components is avoided, the positioning of some of which may prevent, block or interrupt gripping, or even transfer. This also allows the device to adapt to assembly components of different geometries and/or types.

According to another particular feature of the device, at least one of the means for gripping comprises a gripping head mounted movable in translation, along a translation axis parallel to the central axis, at least between:
a first position of gripping at least one extracted assembly component, wherein the gripping head is in the vicinity of the associated means for extracting, and
a second position of transferring the at least one gripped assembly component, the gripping head is distant from the associated means for extracting.

Such a gripping head movable in translation makes it possible in particular to avoid gripped assembly component striking the walls of the containers, and this irrespective of the geometry thereof. This means, in particular, effective transfer of all types of assembly component.

According to another particular feature of the device, the movement of the gripping head from the first position to the second position is initiated by a selective actuator.

Such a selective actuator makes it possible in particular to ensure the activation of a single means for gripping. This can help to minimise the risks of incorrect transfers of assembly components, which can potentially lead to degradation of dedicated assembly means and/or faulty or inappropriate assembly.

According to another particular feature of the device, the selective actuator is a second arm movable in rotation about the central axis, so as to select the means for gripping to be moved, and movable in translation along the central axis, so as to initiate the movement of the selected means for gripping.

According to another particular feature of the device, at least one of the means for gripping comprises means for temporarily securing to the assembly component extracted by the associated means for extracting.

Such a solution makes it possible in particular to ensure the gripping of the assembly component in the means for extracting and its release with respect to the means for conveying to a remote workstation. In particular, this makes it possible to simplify the structure of the device by eliminating the need to use another dedicated release member. This translates in particular into a reduction in costs and the use of raw materials for manufacturing the device.

According to another particular feature of the device, the gripping head has a means for suctioning the extracted assembly component.

Such a pneumatic solution has in particular the advantage of operating with assembly components made of varied materials. For example, it is possible to ensure gripping and transfer of both ferromagnetic and non-ferromagnetic assembly components.

According to another particular feature of the device, the means for suctioning is automatically actuated when the actuator is positioned opposite the gripping head.

Such an automatic activation of the means for gripping, obtained by an alignment of a plurality of portions of fluidic piping, makes it possible in particular to simplify the operation of the device.

According to another particular feature of the device, the means for conveying comprise a plurality of tubes for conveying the assembly components, the tubes for conveying being carried by a unit able to move in translation, along an axis parallel to the central axis.

Such an arrangement makes it possible in particular to adapt to the geometry (length) of the various assembly components to be conveyed to the workstation. The translational movement of the movable unit also ensures the proper engagement of the assembly component in the associated tube for conveying, as well as minimising air leaks when suctioning by the suction units located at the workstation. Using a plurality of tubes for conveying makes it possible in particular to offer an inside tube diameter adapted to the head diameter of the component. In particular, this ensures good efficiency of suction from the workplace. This also makes it possible to have an independent feed depending on the assembly component.

### 5. LIST OF THE FIGURES

Further features and advantages of the invention will become apparent on reading the following description of a specific embodiment, given merely by way of illustrative and non-limiting example, and the appended drawings, wherein:

FIG. 1 illustrates, in an elevated perspective view, an example of a device for storing and dispensing assembly components according to the invention;

FIG. 2 illustrates, in a cross-sectional view, further the structure of the means for transferring assembly components of FIG. 1;

FIG. 3 is a partial view of FIG. 2 focused on the means for gripping belonging to the means for transferring;

FIGS. 4A and 4B illustrate, in different cross-sectional views, the means for conveying extracted components of FIG. 1; and

FIGS. 5A and 5B illustrate, in perspective and cross-sectional views respectively, the central structure of revolution of FIG. 1.

### 6. DETAILED DESCRIPTION OF THE INVENTION

### 6.1 Description of an Illustrative Embodiment

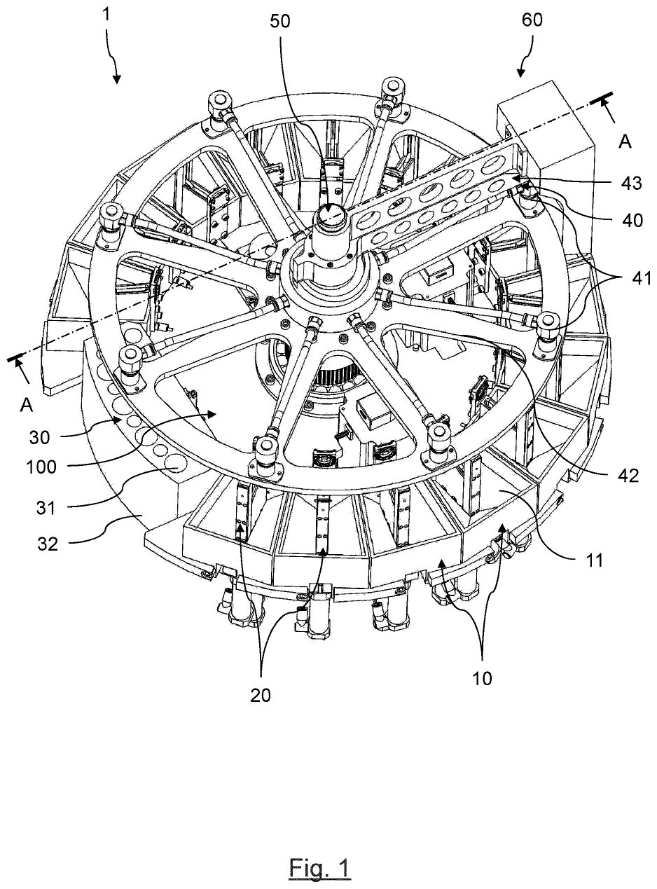

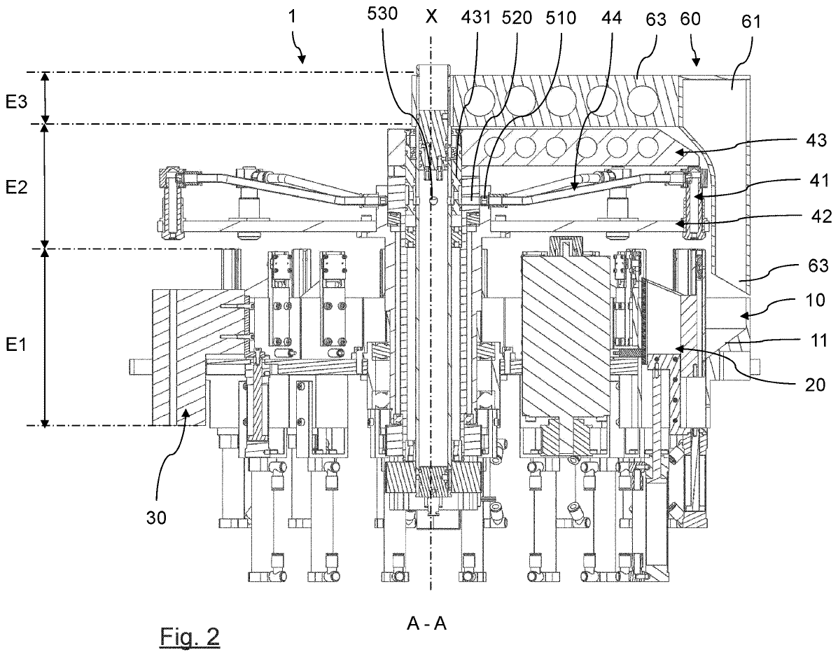

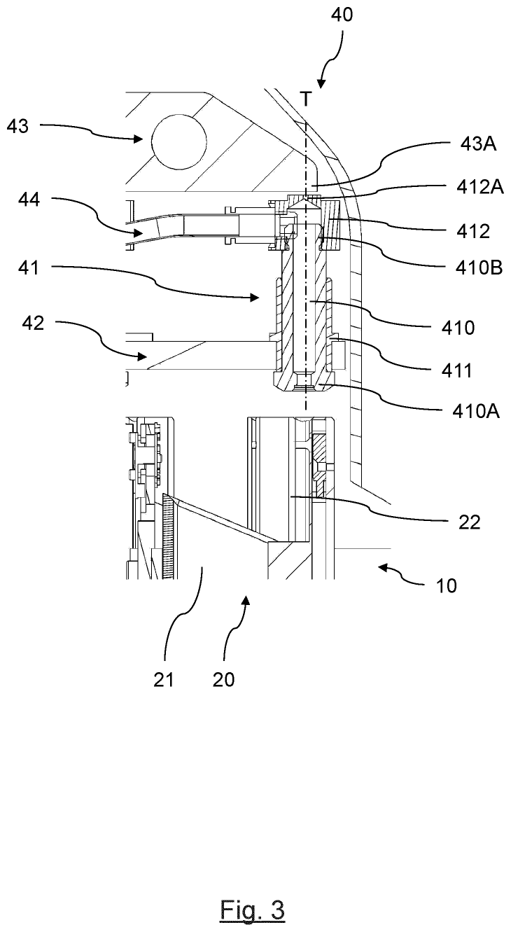

FIGS. 1 to 5B illustrate, in various views, an example of a device for storing and dispensing assembly components in accordance with an embodiment of the invention.

The device 1 for storing and dispensing assembly components conventionally comprises a fixed frame 100 supporting:
a plurality of containers 10 capable of containing assembly components (not shown), preferably of different geometries and/or types (screws, rivets, etc.);
for each container 10, a means for extracting 20, out of the container 10, associated assembly components;
means 30 for conveying assembly components extracted from the containers 10, by the means for extracting 20, to at least one remote workstation (not shown), such as a robotic arm equipped with at least one member for assembling the assembly components coming from the device 1; and
means 40 for transferring, to the means for conveying 30, assembly components extracted from the containers 10 by the means for extracting 20.

In other words, the means for transferring 40 ensure the movement of the assembly components between a first position, referred to as extraction position, in which the assembly components are located at the associated means for extracting 20, and a second position, referred to as conveying position, in which the extracted assembly components are located at the means for conveying 30.

According to the invention, the containers 10 of the device 1 are arranged radially around a central axis X.

Furthermore, the means for transferring 40 comprise means 41 for gripping at least one assembly component extracted by the means for extracting 20.

The means for gripping 41 are respectively carried by an arm 42 movable in rotation about the central axis X so as to transfer to the distribution means 30 each assembly component extracted from the container 10 from which it is extracted.

Thus, in accordance with the general principle of the invention, each assembly component extracted from a container 10 is transferred from the extraction position to the conveying position in a rotational movement about the central axis X.

More specifically, in this embodiment, the device 1 comprises:
a first stage E1, having a first altitude,
a second stage E2, having a second altitude, the second altitude being higher than the first altitude, and
   a third stage E3, having a third altitude, the third altitude being higher than the first and second altitudes.

Such a staged arrangement makes it possible in particular to reduce the footprint of the device 1 and to ensure a precise and effective transfer of the assembly components.

The frame 100 of the device 1 supports, on the first stage E1, the containers 10 and the means for conveying 30. These are arranged radially around the central axis X so as to substantially define a segmented ring.

In the illustrated example, the means for conveying 30 are centralised, i.e. they define a single segment of the ring.

The means for conveying 30 comprise a plurality of tubes for conveying 31 of different diameters so as to allow the passage of assembly components of different geometries and/or types.

More precisely, the tubes for conveying 31 have diameters adapted to the various assembly components and are connected to suction units located at the workstation (not shown) thus enabling the movement of the components from the storage device to the workstation to be ensured. These means for suctioning are known to a person skilled in the art. Examples include an ejector, a central suction system, etc.

The tubes for conveying 31 are carried by a unit 32 able to move in translation along an axis parallel to the central axis X, between a low position and a high position, so as to adapt to the geometry (length) of the assembly components to be discharged.

The translation of the movable unit 32 between the low position and the high position, and vice versa, is initiated by a cylinder 34 the body of which is secured to the frame 100.

Each container 10 is provided with a bottom 11 having a slot (unreferenced) in which the associated means for extracting 20 is able to move, along a vertical axis parallel to the central axis X, between a low position (not illustrated), of taking a plurality of assembly components from the bottom 11 of the associated container 10, and a high position, of extracting the plurality of assembly components from the associated container 10.

In the illustrated example, the means for extracting 20 respectively have a first part 21, comprising a first housing suitable for receiving a plurality of assembly components, and a second part 22, comprising a second housing suitable for receiving a single assembly component belonging to the plurality of assembly components.

The two parts 21, 22 are movable in translation with respect to one another along the vertical axis. The second part 22 is moreover configured to take a unit dispensing position in which the assembly component contained in the second housing of the second portion 21 is longitudinally offset, along the vertical axis, from the assembly components contained in the first housing of the first portion 21.

Such means for extracting 20 in two movable parts make it possible to orient the assembly components extracted from the container vertically, then to arrange them in a unitary manner opposite the associated means for gripping 41.

The frame 100 furthermore carries a central structure 50 a revolution, formed of three coaxial hollow tubes 51, 52, 53, extending along the central axis X and arranged coaxially therewith.

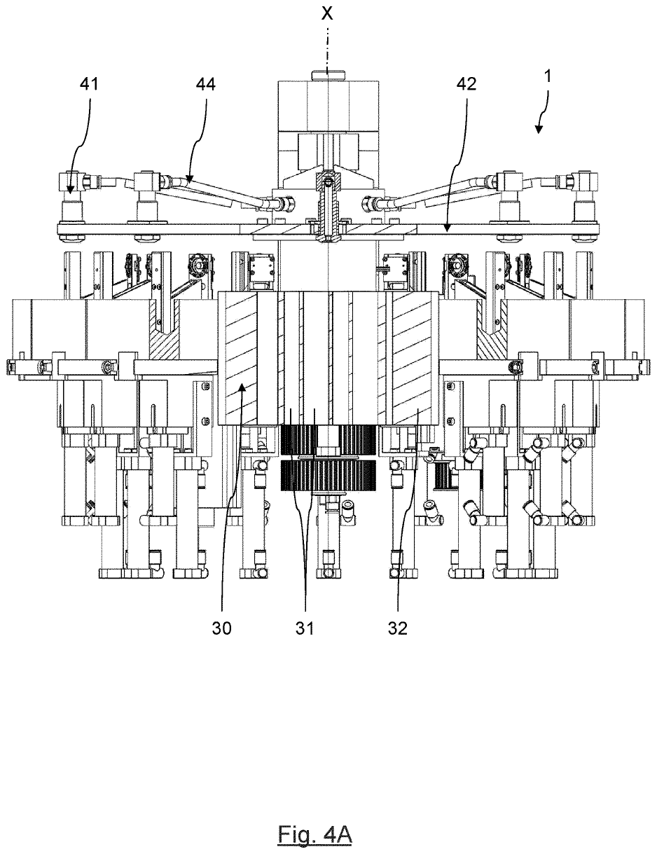

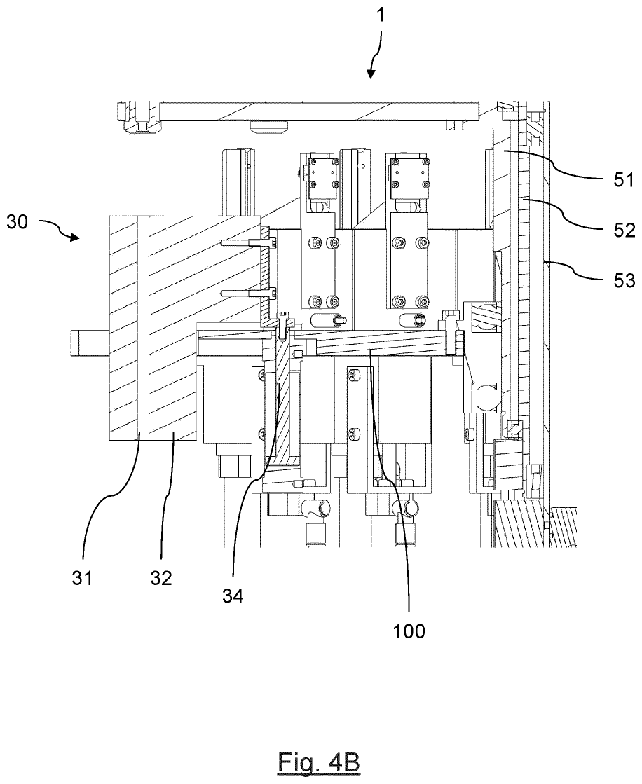

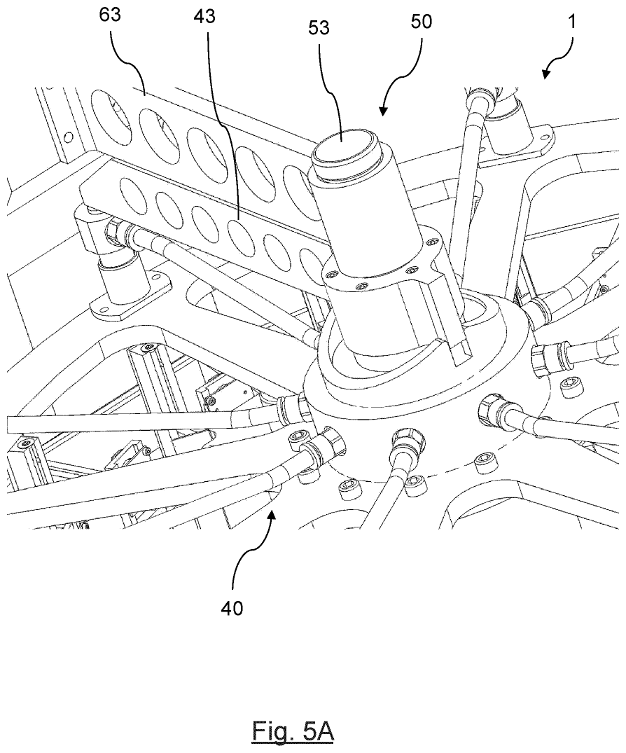

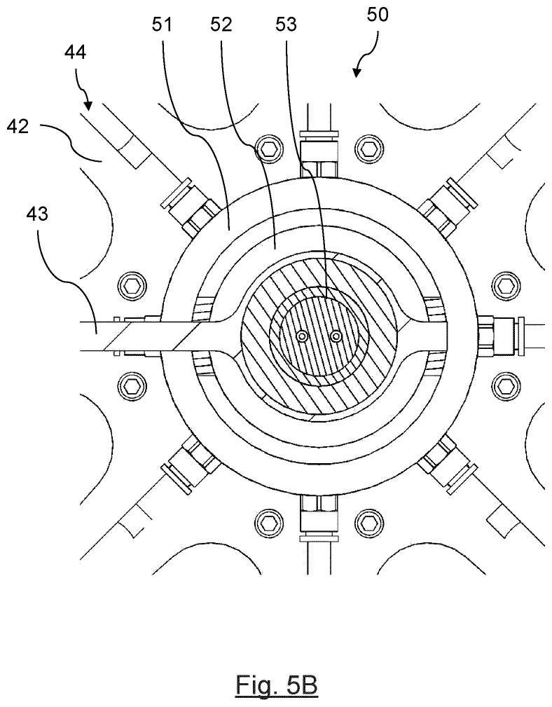

More precisely, the central structure 50 of revolution, more visible in FIGS. 4B, 5A and 5B, comprises:
an outer tube 51, configured to support, at the second stage E2, the means 40 for transferring the gripped assembly components;
a central tube 53, configured to support, at the third stage E3, means 60 for supplying the containers 10 with assembly components; and
an intermediate tube 52, configured to support, at the second stage E2, an actuator 43 of a translation of the means for gripping 41, detailed later.

The means for gripping 41 are furthermore located at a predetermined distance from the central axis X so as to be vertically aligned, on the one hand, with the means for extracting 20 to enable gripping of the extracted assembly components and, on the other hand, with the means for conveying 30 to enable discharge of the gripped assembly components.

Thus the means 41 for gripping the extracted assembly components are located above the means for extracting 20 and the means for conveying 30 and move from one to the other in rotational movements.

The means for gripping 41 are also movable in translation, on an axis T oriented parallel to the central axis X, between a low position, of unitary gripping of the assembly component extracted by the associated means for extracting 20, and a high position, of transferring the gripped assembly component.

A controllable actuator 43 is also provided, for causing the movement of the means for gripping 41 from the upper position to the lower position, and return means (not shown) for ensuring, when the actuator 43 is no longer controlled, the return of the means for gripping 41 to the upper position.

Such an arrangement makes it possible in particular to ensure, in the low position, an easy gripping of the extracted assembly component, and this irrespective of its dimensions. Such an arrangement also makes it possible to ensure an effective gripping and holding of an end, preferably the head, of the assembly component extracted by the associated means for extracting.

In the illustrated example, the gripping and holding of the assembly component head is provided, temporarily, by pneumatic means 41 for gripping. Such a pneumatic solution has in particular the advantage of operating with assembly components made of varied materials.

More precisely, the arms 42, the ends of which are secured together so as to substantially form a spoked wheel, are mounted rotatably movable on the outer tube 51.

Preferably, the angular spacing between the arms 42 is identical in order to ensure a homogeneous distribution of the mass of the arms 42 and of the means for gripping 41 carried by them. Furthermore, each pneumatic means for gripping 41 comprises a hollow gripping head 410 mounted so as to be able to slide along the translation axis T, inside a guide sleeve 411 integral with the associated arm 42.

The gripping head 410 has a first so-called proximal end 410A forming a means for suctioning, able to grip and hold a head of an assembly component extracted by the associated means for extracting 20, and a second o-called distal end 410B secured and pneumatically coupled to a base 412 of a translation stop.

Such a base 412 is configured to cooperate with the actuator 43 to allow the gripping head 410 to slide from the upper position to the lower position of gripping an extracted assembly component.

To this end, the base 412 has, in line with the gripping head 410, on the translation axis T, a bearing surface 412A, forming an anvil, configured to cooperate with an end 43A of the actuator 43.

This actuator 43 is formed by a second arm mounted on the intermediate tube 52 of the central structure 50 able to move, on the one hand, in rotation about the central axis X so as to align with the desired gripping head 410 and, on the other hand, in translation along this central axis X, via a piston 431, so as to cooperate with the bearing surface 412A of the base 412 of the gripping head 410 selected to lower it against the extracted assembly component.

The return means (not shown), ensuring the return of the gripping head 410 to the initial position, is formed by a coil spring disposed around the gripping head 410 and between the guide sleeve 411 and the base 412.

The base 412 is also configured to be connected to a pneumatic power supply, itself configured to create a suction air flow (for gripping an assembly component) or, if necessary, an expiration air flow (for forced ejection of an assembly component).

In the illustrated example, the pneumatic energy supply (not shown) is connected to the lower longitudinal end of the central tube 53 to allow a flow of air to pass therein.

At the second stage E2 of the device 1, the central structure 50 has:
on the wall of the central tube 53, orifices 530 formed radially;
in the intermediate tube 52, a channel 520 formed radially;
in the outer tube 51, connectors 510 for connecting fluidic piping 44 formed radially.

Thus, when the actuator 43 is positioned opposite a specific gripping head 410, there is a radial alignment of the associated orifice 530 of the central tube 53, the channel 520 of the intermediate tube 52 and the associated fitting 510 of the outer tube 51. This allows the creation of a passage for fluidic supply to the gripping head 410.

In other words, in addition to driving the gripping head 410 in translation from its upper position to its lower position, the actuator 43 also makes it possible to control, via the channel 520 provided in the intermediate tube 52, the passage of the air flow therein to ensure the gripping of the assembly component.

The gripping head 410 furthermore carries a sensor (not shown) for the presence of an assembly component positioned at its first end 410A to verify the presence of such a component in the means for suctioning.

In this example, the means for supplying 60 comprise a hopper 61 the discharge portion 62 of which is vertically aligned with the containers 10 and supported by a third arm 63 movable in rotation on the central axis X.

The device furthermore comprises at least one processor coupled to a memory, for example RAM, on which a computer program is recorded to ensure the described operation of the device 1, which is partially described hereinafter.

Such a device 1 for storing and dispensing assembly components comprises in particular the following main steps:
in a prior step, it was indicated, by suitable means, to the device 1 that a particular type of assembly component present in the container 10 must be conveyed to the workstation;
in a first so-called extraction step, of extraction of the assembly component, the means for extracting 20 associated with the container 10 is controlled, by means of cylinders, to, firstly, descend to the low position to take a plurality of assembly components from the bottom 11 of the container 10 and, secondly, successively rising to the upper position then to the position of unitary dispensing of an assembly component coming from the plurality of assembly components. At the end of this first step, at least one of the assembly components extracted from the container 10 is oriented vertically and located opposite the associated gripping head 41.

in a second so-called gripping step, the actuator 43 of the means for transferring 40 is controlled to pivot about the intermediate tube 52 to position itself above the associated means for gripping 41. When the actuator 43 is aligned with the means for gripping 41, there is a radial alignment of the associated orifice 530 of the central tube 53, the channel 520 of the intermediate tube 52 and the associated coupling 510 of the outer tube 51. This creates a passage for fluidic supply of the means for suctioning 410A. The actuator 43 is then controlled to slide along the intermediate tube 52 to exert a pressure on the means for gripping 41 so as to lower it from the upper position to the lower position, in which the means for gripping 41 comes into contact with the extracted assembly component and grips it.
in a third step, the means for extracting 20 is controlled to return to the upper position, i.e. to descend, in order in particular to release the assembly component gripped by the means for gripping 41.
in a fourth step, the actuator 43 is controlled to rise by sliding along the intermediate tube 52. This translation, combined with the means for returning the gripping head 410, allow it to return to the upper position (initial position).
in a fifth step, the arm 42 is controlled to pivot about the outer tube 51 to move, in a rotational movement, the means for gripping 41 and the assembly component gripped thereby toward and above the associated tube for conveying 31 belonging to the means for conveying 30. Such a simultaneous movement of the arms 42 and the actuator 43 is necessary to ensure a continuity of suction and therefore of holding of the assembly component by the gripping head 410,
in a sixth step, the actuator 43 is controlled to slide along the intermediate tube 52 to exert pressure on the means for gripping 41 so as to lower it from the upper position to the lower position, wherein the gripped assembly component is inserted into the associated tube for conveying 31,
in a seventh, optional, step, the vertical position of the means for conveying 30 is adjusted to allow the insertion and passage of the gripped assembly component into the associated tube for conveying 31,
in a seventh step, the operation of the means for suctioning 410A is interrupted to allow the gripped assembly component to be released into the associated tube for conveying 31. Preferably, the suction unit coupled to the associated tube for conveying 31 is activated, to allow suction of the assembly component as far as the workstation. Such suction is achieved by controlling the pressure, time and flow rate depending on the type and/or geometry of the assembly component.

### 6.3 Other Embodiments and Variants

In the illustrated embodiment, the means for conveying 30 are centralised among the containers, i.e. they define a single segment of the segmented ring. According to another embodiment, not shown, an alternation of means for conveying and of one or more containers may be envisaged. Such an alternative arrangement is of interest when the device 1 is intended to supply several workstations in particular.

In the illustrated embodiment, the means for conveying 30 comprise a unit 32 able to move in translation along an axis parallel to the central axis X, between a low position and a high position, so as to adapt to the geometry (length) of the assembly components to be discharged. According to another embodiment, not shown, the means for conveying can be fixedly mounted on the frame. In particular, this can help to reduce the costs of the device.

In the illustrated embodiment, the means for extracting 20 comprise two parts able to move relative to one another so as to orient the assembly components extracted from the container vertically, and then arrange them unitarily opposite the associated means for gripping 41. However, any other solution allowing at least one or more assembly components to be extracted in a vertical orientation may alternatively be envisaged.

In the illustrated embodiment, gripping and holding of the assembly component head are provided, temporarily, by pneumatic means for gripping. However, any other solution ensuring a temporary (i.e. controlled) gripping of the extracted assembly component may be envisaged alternatively. For example, for the assembly components made of ferromagnetic materials, it may be envisaged using electromagnets. Such a solution can help to simplify the structure of the device, in particular that of the central structure of revolution.

In the illustrated embodiment, the gripping head is movable in translation on the associated arm in order to come into contact with the extracted assembly component. According to another embodiment, not shown, the gripping head is fixed. In this alternative embodiment, the means for extracting are configured so that the dispensing position allows the extracted assembly component to contact the fixed gripping head. Such an alternative can help to simplify the structure of the device.

Obviously, the invention is not limited to the embodiments described above and provided merely by way of example. It encompasses various modifications, alternative forms and other variants that a person skilled in the art can consider in the context of the present invention and in particular all combinations of the various operating modes described before, which can be considered separately or in combination.

More generally, the invention covers all implementations of the principle according to which each assembly component extracted from a container is transferred from the extraction position, outside the container by suitable means, to the conveying position, to a workstation, in a rotational movement about the central axis.

According to various aspects, the invention therefore has all or some of the following advantages, depending on the adopted embodiments:
improving the accuracy and/or efficacy of gripping an assembly component with a view to transfer thereof;
improving the transfer rate of the assembly components;
adapting to assembly components of different geometries and/or types;
limiting the footprint of the assembly component storage and dispensing device;
guaranteeing a long service life;
requiring limited maintenance;
limiting manufacturing costs;
etc.

An exemplary aspect of the present disclosure provides an effective solution to at least some of these various problems.

An exemplary aspect of the present disclosure improves the transfer of the assembly components extracted from an associated container to means of conveyance to a workstation.

In particular, an exemplary aspect provides a transfer means for improving the accuracy and efficiency of gripping an assembly component with a view to its transfer and/or during it.

In particular, an exemplary aspect provides, in at least one embodiment, a device for storing and dispensing assembly components using at least one such transfer means.

An exemplary aspect of the present disclosure provides such a transfer means making it possible to improve the transfer rate of the assembly components.

An exemplary aspect of the present disclosure provides such a transfer means adapted to assembly components of different geometries and/or types.

An exemplary aspect of the present disclosure provides, in at least one embodiment, such a device for storing and dispensing assembly components that is simple to implement and/or compact and/or economical.

Although the present disclosure has been described with reference to one or more examples, workers skilled in the art will recognize that changes may be made in form and detail without departing from the scope of the disclosure and/or the appended claims.

1. A device for storing and dispensing assembly components comprising:
a plurality of containers capable of containing assembly components and arranged radially around a central axis,
extractors arranged to extract, out of said containers, assembly components, each extractor being respectively associated with each of said containers,
a conveying device which conveys, to at least one remote workstation, assembly components extracted from said containers by said extractors,
a transfer device arranged to transfer, to said conveying device, assembly components extracted from said containers by said extractors,
wherein said transfer device comprises grippers arranged to grip at least one assembly component extracted by at least one of said extractors, each of said grippers being respectively carried by an arm movable in rotation about said central axis so as to transfer to said conveying device each assembly component extracted from one of said containers from which the assembly component is extracted.

2. The device for storing and dispensing according to claim 1, wherein at least one of said grippers is a unitary gripper of an assembly component extracted by said associated extractor.

3. The device for storing and dispensing according to claim 1, wherein at least one of said grippers comprises a gripping head mounted movable in translation, along a translation axis parallel to said central axis, at least between:
a first position of gripping at least one extracted assembly component, wherein said gripping head is in a vicinity of said associated extractor, and
a second position of transferring said at least one gripped assembly component, said gripping head being distant from said associated extractor.

4. The device for storing and dispensing according to claim 3, comprising a selective actuator, wherein the movement of said gripping head from the first position to the second position is initiated by the selective actuator.

5. The device for storing and dispensing according to claim 4, wherein said selective actuator is a second arm movable in rotation about said central axis, so as to select said grippers to be moved, and movable in translation along said central axis, so as to initiate the movement of said selected grippers.

6. The device for storing and dispensing according to claim 1, wherein at least one of said grippers comprises means for temporarily securing to said assembly component extracted by the associated extractor.

7. The device for storing and dispensing according to claim 6, wherein said gripping head has a suction device positioned to suction said extracted assembly component.

8. The device for storing and dispensing according to claim 7, comprising a selective actuator, wherein the movement of said gripping head from the first position to the second position is initiated by the selective actuator, and wherein said suction device is automatically actuated when said selective actuator is positioned opposite said gripping head.

9. The device for storing and dispensing according to claim 1, wherein said conveying device comprise a plurality of tubes for conveying said assembly components, said tubes for conveying being carried by a unit movable in translation, along an axis parallel to said central axis.
